(19) United States
(12) Patent Application Publication
(10) Pub. No.: US 2013/0333229 A1
(43) Pub. Date: Dec. 19, 2013

(54) SWIVEL-CLAMP REACH EXTENSION POLE DEVICE

(71) Applicant: Jack Webster Williams, Folsom, LA (US)

(72) Inventor: Jack Webster Williams, Folsom, LA (US)

(21) Appl. No.: 13/526,513

(22) Filed: Jun. 18, 2012

(51) Int. Cl. A01D 34/90; B25G 3/38; B25G 1/00

(52) U.S. Cl. 30/296.1; 81/491; 29/428

(57) ABSTRACT

A swivel and extension pole allows a user to stand straight up and weed trim in a relaxed position. The extension pole has a swivel attachment that attaches to a tool, such as a weed trimmer, allowing the user to operate the weed trimmer with two hands. This design requires less bending than with conventional weed trimmers and allows the user to trim a yard in less time as compared with conventional methods.

### BACKGROUND OF THE INVENTION

The present invention relates to extension/support poles and, more particularly, to an extension pole having a swivel clamping device disposed at the end thereof.

Many tasks are performed that involve controlling a heavy apparatus disposed at the end of a shaft. For example, mopping includes an often heavy mop at the end of a mop handle. Weed trimming is another example of a device that includes a heavy trimmer line reel and often a guard, at the end of a shaft. The weed trimmer is even more difficult and tiring to control, as it is kept above the surface of the ground.

Often, to move these devices from side to side, a user holds on near the end of the shaft with one hand and provides a force with the other hand.

Because the spacing between the user's hands on the shaft are limited, the force that can be generated between the lever and fulcrum (the user's hands) is limited.

As can be seen, there is a need for an extension pole that can clamp on a handle of a device to help in the use and movement of the device.

### SUMMARY OF THE INVENTION

In one aspect of the present invention, a swivel-clamp extension pole assembly comprises an extension pole; a U-joint bracket pivotably attached at an end of the extension pole; a clamp rotatably attached to the U-joint bracket; and a clamp fastener tightenable to secure the clamp to a tool.

In another aspect of the present invention, a method for operating a weed trimmer comprises attaching an extension pole to a neck of the weed trimmer, the extension pole attached via a swivel-clamp assembly to the neck of the weed trimmer; and holding the weed trimmer in one hand and holding the extension pole in the other hand to operate the weed trimmer.

In a further aspect of the present invention, a weed trimmer comprises a weed trimmer handle extending from a weed trimmer head; an extension pole; a U-joint bracket pivotably attached at an end of the extension pole; a clamp rotatably attached to the U-joint bracket; and a clamp fastener tightenable to secure the clamp to the weed trimmer handle proximate to the weed trimmer head.

These and other features, aspects and advantages of the present invention will become better understood with reference to the following drawings, description and claims.

### BRIEF DESCRIPTION OF THE DRAWINGS

FIG. 1 is a perspective view of a swivel-clamp extension pole device, in use with a weed trimmer, according to an exemplary embodiment of the present invention;

FIG. 2 is a perspective view of the swivel-clamp extension pole device of FIG. 1;

FIG. 3 is a right-hand side detailed perspective view of an attachment end of the swivel-clamp extension pole device of FIG. 1;

FIG. 4 is a left-hand side detailed perspective view of an attachment end of the swivel-clamp extension pole device of FIG. 1;

FIG. 5 is a side view of the swivel-clamp extension pole device of FIG. 1, showing pivoting of the attachment end; and

FIG. 6 is an end view of the swivel-clamp extension pole device of FIG. 1, showing rotation of the attachment end.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a swivel and extension pole that allows a user to stand straight up and weed trim in a relaxed position. The extension pole has a swivel attachment that attaches to a tool, such as a weed trimmer, allowing the user to operate the weed trimmer with two hands. This design requires less bending than with conventional weed trimmers and allows the user to trim a yard in less time as compared with conventional methods.

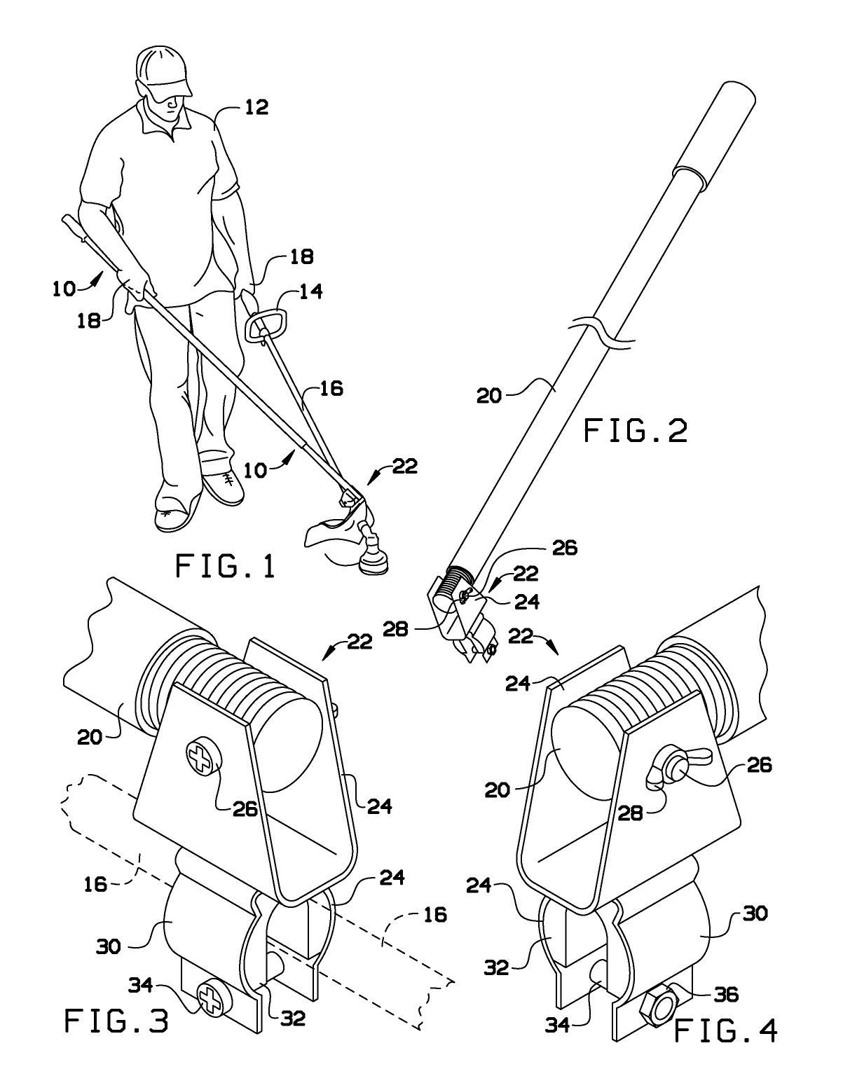

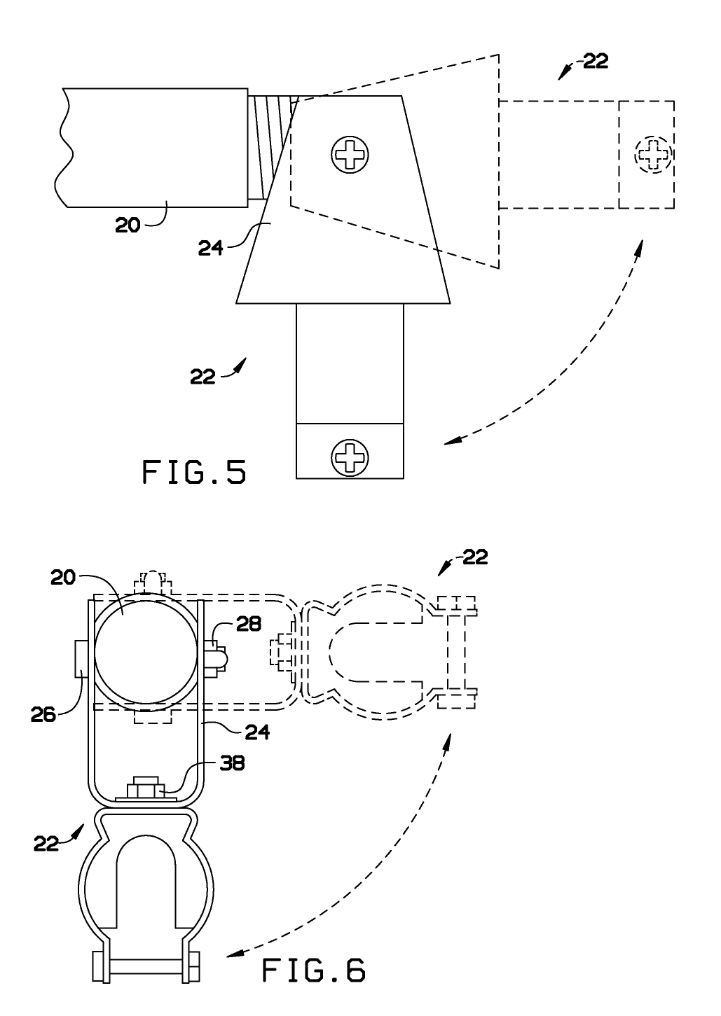

Referring now to FIGS. 1 through 6, a swivel extension pole assembly 10 can be held by an operator 12 with their other hand 18 on a tool, such as a weed trimmer 14. The swivel extension pole assembly 10 can attach, via a swivel-clamp assembly 22, at a neck 16 of the weed trimmer 14.

The swivel extension pole assembly 10 includes an extension pole 20 with the swivel-clamp assembly 22 attached to one end thereof. The swivel-clamp assembly 22 includes a U-joint bracket 24 and a clamp 30, such as a conduit clamp, attached together. The U-joint bracket 24 includes a U-joint fastener 26 that can pass through holes in the ends of the U-joint bracket 24 along with a hole through the end of the extension pole 20. A fastener, such as a U-joint wing nut 28 may secure the U-joint bracket 24 to the extension pole 20. In some embodiments, the U-joint wing nut 28 is a stop nut, allowing the nut to be fastened loosely, allowing the U-joint bracket 24 to pivot on the end of the extension pole 20.

The clamp 30 can attach to the U-joint bracket 24 via a fastener 38. The fastener 38 can include a bolt with a stop nut so that, similar to the U-joint fastener 26 and nut 28, the fastener 38 can secure the U-joint bracket 24 to the clamp 30, but still allow one to rotate relative to the other.

A cushion 32 may be disposed inside the clamp 30. The cushion 32 may allow the clamp 30 to attach to the tool 14 securely. A clamp fastener 34 and a clamp nut 36 may be used to tighten the clamp 30 onto the tool 14.

As shown in FIGS. 5 and 6, the swivel-clamp assembly 22 allows pivoting and rotation motion of the tool 14 during use. The weed trimmer 14 and the extension pole 20 work together to balance and keep the user from bending. The extension pole 20 allows the weed trimmer 14 to move easier from side to side, allowing the user to work quickly and comfortably. The swivel-clamp assembly 22 allows a user to twist the weed trimmer 14 with a twist of the wrist and use it as an edger. The device of the present invention also allows the weed trimmer 14 to go under buildings without bending. A user can go to ditches and extend the pole to weed trim and still be in an upright position. The device can also be used to trim high hedges because it extends and balances easily.

The extension pole 20 may be a solid member, typically from about 2 to about 3 feet long, but may also be an adjustable length extension pole, adjusting via various mechanisms as may be known in the art. While the drawings show a corrugated or threaded end on the extension pole 20, it could be solid, tapered, square, or some other shape. In some embodiments, a sleeve, such as an aluminum sleeve, may fit along the end of the extension pole 20 for additional support. The extension pole 20 can be made of various materials, such as wood, fiberglass, or the like.

It should be understood, of course, that the foregoing relates to exemplary embodiments of the invention and that modifications may be made without departing from the spirit and scope of the invention as set forth in the following claims.

What is claimed is:

1. A swivel-clamp extension pole assembly comprising:
an extension pole;
a U-joint bracket pivotably attached at an end of the extension pole;
a clamp rotatably attached to the U-joint bracket; and
a clamp fastener tightenable to secure the clamp to a tool.

2. The swivel-clamp extension pole assembly of claim 1, further comprising a cushion disposed inside the clamp and adapted to be positioned between the clamp and the tool.

3. The swivel-clamp extension pole assembly of claim 1, further comprising a U-joint fastener passing through holes in the ends of the U-joint bracket and through a hole in the end of the extension pole.

4. The swivel-clamp extension pole assembly of claim 1, further comprising a fastener joining the U-joint bracket with the clamp.

5. A method for operating a weed trimmer comprising:
attaching an extension pole to a neck of the weed trimmer, the extension pole attached via a swivel-clamp assembly to the neck of the weed trimmer; and
holding the weed trimmer in one hand and holding the extension pole in the other hand to operate the weed trimmer.

6. The method of claim 5, further comprising securing a clamp to the neck of the weed trimmer, the clamp rotatably attached to a U-joint bracket, the U-joint bracket pivotably attached to the extension pole.

7. The method of claim 6, further comprising securing the clamp to the neck of the weed trimmer by tightening the clamp to the neck of the weed trimmer with a cushion disposed therebetween.

8. A weed trimmer comprising:
a weed trimmer handle extending from a weed trimmer head;
an extension pole;
a U-joint bracket pivotably attached at an end of the extension pole;
a clamp rotatably attached to the U-joint bracket; and
a clamp fastener tightenable to secure the clamp to the weed trimmer handle proximate to the weed trimmer head.

9. The weed trimmer of claim 8, further comprising a cushion disposed inside the clamp and adapted to be positioned between the clamp and the tool.

10. The swivel-clamp extension pole assembly of claim 8, further comprising a U-joint fastener passing through holes in the ends of the U-joint bracket and through a hole in the end of the extension pole.
